(19) United States
(12) Patent Application Publication
(10) Pub. No.: US 2010/0224831 A1
(43) Pub. Date: Sep. 9, 2010

(54) NANOPARTICLE-DOPED POROUS BEAD AND FABRICATION METHOD THEREOF

(76) Inventors: Kyoungja WOO, Seoul (KR); Myungje CHO, Seoul (KR)

Correspondence Address: OSTROLENK FABER GERB & SOFFEN, 1180 AVENUE OF THE AMERICAS, NEW YORK, NY, 100368403, US

(21) Appl. No.: 12/618,897

(22) Filed: Nov. 16, 2009

(30) Foreign Application Priority Data
Mar. 6, 2009 (KR) 10-2009-0019456
Jul. 1, 2009 (KR) 10-2009-0059930

(51) Int. Cl. C09K 11/54; C09K 11/77; C09K 11/08

(52) U.S. Cl. 252/301.6 S; 427/157; 252/301.4 R; 252/301.6 R; 252/301.4 H

(57) ABSTRACT

Disclosed are a nanoparticle-doped porous bead with a highly enhanced photoluminescence without wavelength shift and improved durability, and a fabrication method thereof, the nanoparticle-doped porous bead comprising porous beads, and nanoparticles radially bonded onto homocentric spheres of the porous beads by an electrostatic attractive force, the homocentric sphere located inside the porous bead near a surface thereof, wherein the nanoparticles are photoluminescent nanoparticles or mixed nanoparticles of photoluminescent nanoparticles and another nanoparticles, wherein the another nanoparticle is one or more than two mixed, selected from a group consisting of magnetic nanoparticle, metallic nanoparticle and metal oxide nanoparticle.

### CROSS-REFERENCE TO A RELATED APPLICATION

Pursuant to 35 U.S.C. §119(a), this application claims the benefit of earlier filing date and right of priority to Korean Applications No. 10-2009-0019456, filed on Mar. 6, 2009 and Korean Applications No. 10-2009-0059930, filed on Jul. 1, 2009, the content of which are incorporated by reference herein in its entirety.

### BACKGROUND OF THE INVENTION

1. Field of the Invention

The present invention relates to a nanoparticle-doped porous bead having an enhanced fluorescence intensity without wavelength shift, improved durability, and a fabrication method thereof.

2. Background of the Invention

Purcell expressed a theoretical predication in 1946 that if a luminous body is placed near the surface of a porous bead with a size of several tens nanometer to several tens micron, luminance intensity would be enhanced much higher than only the luminous body being used alone, due to a resonance coupling between the photons emitted from the luminous body and the photonic states of the porous cavities and the highest electromagnetic field near the surface of a porous bead. This theory predicted that a porous body consisting of a material with a high refractive index would be greatly amplified, and, for the same porous body, luminance would be effectively enhanced when luminous bodies were radially formed in the same distance from the center of the porous bead. That is, it was predicted that the self quenching would be minimized and fluorescence would be enhanced highly by the resonance coupling of the photons with the cavity modes when a photoluminescent layer has a monolayer thickness in form of spherically thin shell.

In recent time, as a quantum dot synthesis with superior fluorescence property is developed, studies on doping the quantum dots on silica have been attempted.

From the studies on fabrication of silica bead with quantum dots doped in form of raisin bun or with a single quantum dot doped at a center thereof [Chem. Mater. 2000, 12(9), 2676-2685 and Angew. Chem. Int. Ed. 2004, 43, 5393-5396], the former caused the result that the final fluorescence intensity was rather decreased due to the self quenching between quantum dots located within different distances from the center of the bead, while the latter caused the result that the emitted fluorescence was extremely weakened because the quantum dot was doped deeply inside the silica bead.

Meanwhile, since the silica surface naturally has partially negative charge and the nanoparticle surface naturally has partially positive charge due to the properties of the materials themselves without any additional surface modification of silica beads or nanoparticles, it was attempted to dope a nanoparticle layer into the silica bead using such natural electrostatic force [Langmuir 2005, 21(21), 9412-9419]. However, in this case, because the amounts of charges of the surfaces of the silica beads and the nanoparticles were not sufficient, the electrostatic force was too weak to uniformly dope the nanoparticle layer on the surface of the silica beads. Additionally, most of the doped nanoparticles were separated during reaction of growing a silica layer on the nanoparticles.

From another study [Nano Lett. 2001, 1(6), 309-314], the silica bead was treated with trialkoxysilane having a mercapto group to expose the mercapto group on the silica, which was then directly reacted with the quantum dots so that the mercapto group could substitute a ligand of the surface of the quantum dots, thereby fabricating a quantum dot layer. However, in this case, the bonding between the mercapto groups and the quantum dots is similar to a covalent bond, and is a multiple bond simultaneously generating several bonding. Accordingly, once being bonded, the quantum dots cannot be relocated on the silica, which causes a non-uniform arrangement and generation of many empty spaces. That is, the quantum dots of the quantum dot layer are non-uniformly and loosely distributed, resulting in insufficient fluorescence intensity, so a problem in usage may occur.

From the more recent report [Small, 2005, 1(2), 238-241], according to a so-called layer by layer (LBL) mechanism, namely, in which polyelectrolytes consisting of polymers with different charges are alternately doped on silica bead three times so that the silica bead can have polycationic charges on its surface, a quantum dot layer is doped on the polyelectrolyte-doped silica bead, and then polymers with polycationic charges are doped onto the resultant quantum dot layer, the polymer layer and the quantum dot layer were doped three times and one time, respectively, and then the polymer layer was re-doped three times, thereafter growing a silica layer on the resultant layer. In this report, any aspect of enhancement in the fluorescence has not been informed, only reporting on a blue shift phenomenon that fluorescence is shifted toward high energy as the doping layers are increased. The blue shift is explained to be caused by refractive index mismatch between silica and polymer. From our experience, this can be additionally interpreted as a situation that the available size of quantum dot is decreased due to oxidation proceeding on the surface of the quantum dot caused by the polycationic polymer doping, and it is difficult to constantly maintain or predict the size of blue shift for each reaction. Further, since the thickness of the doped polymer layer is partially non-uniform, the quantum dots of the quantum dot layer are not uniformly distributed, resulting in the chance of weakening the fluorescence intensity.

In the meantime, although a report has been made in which after a polyelectrolyte layer consisting of polymers with different charges was doped on a polystyrene bead, other than the silica bead, three times according to the LBL mechanism so that the polystyrene bead can have polycationic charges, a quantum dot layer was doped thereon, and then the polyelectrolyte layer was doped on the quantum dot layer, so the resultant layer was used in a bio-imaging, such material also has the drawbacks of the aforesaid case of doping the polyelectrolyte layer on the silica bead, on which the quantum dots were then doped. In addition, in this report, since the polystyrene bead is an organic component, if it is used to make a device, for long-term use, such as laser or LED material, a problem in durability may occur.

### SUMMARY OF THE INVENTION

Therefore, to overcome the drawbacks of the related art, an object of the present invention is to provide a photoluminescent body capable of ensuring improved photo-stability, durability and enhanced fluorescence intensity without wavelength shift by allowing a monolayer of inorganic photoluminescent nanoparticles to be uniformly doped inside a porous bead near a surface thereof, without using an organic polymer, and a fabrication method thereof. More particularly, the present invention provides a doped bead simultaneously having photoluminescence properties and properties, such as magnetism, of another particles, by mixing photoluminescent nanoparticles together with another nanoparticles, such as magnetic nanoparticles, metallic nanoparticles or metallic oxide nanoparticles, and a fabrication method thereof.

To achieve these and other advantages and in accordance with the purpose of the present invention, as embodied and broadly described herein, there is provided a nanoparticle-doped porous bead including, porous beads, and nanoparticles radially bonded onto homocentric spheres of the porous beads by an electrostatic attractive force, the homocentric sphere located inside the porous beads near a surface thereof, wherein the nanoparticles are photoluminescent nanoparticles or mixed nanoparticles of photoluminescent nanoparticles and another nanoparticles, wherein the another nanoparticle is one or more than two mixed, selected from a group consisting of magnetic nanoparticle, metallic nanoparticle and metal oxide nanoparticle.

In another aspect of the present invention, there is provided a nanoparticle-doped porous bead including, centric porous beads, nanoparticles bonded to the surfaces of the centric porous beads by an electrostatic attractive force, and a porous layer configured to cover the nanoparticles, wherein the nanoparticles are photoluminescent nanoparticles or mixed nanoparticles of photoluminescent nanoparticles and another nanoparticles, wherein the another nanoparticle is one or more than two mixed, selected from a group consisting of magnetic nanoparticle, metallic nanoparticle and metal oxide nanoparticle.

In another aspect of the present invention, there is provided a method for fabricating a nanoparticle-doped porous bead including, (a) preparing a monodispersed nanoparticle solution and a monodispersed porous bead solution, having opposite charges from each other, by respectively adjusting pH of a nanoparticle solution containing nanoparticles on which molecules chargeable into a first charge are bonded and pH of a porous bead solution containing porous beads on which molecules chargeable into a second charge are bonded, the first charge and the second charge having opposite charges, (b) mixing the monodispersed nanoparticle solution and the monodispersed porous bead solution so as to bond the nanoparticles onto the surfaces of the porous beads, by an electrostatic attractive force, and (c) forming a porous layer to cover the nanoparticles bonded onto the respective surfaces of the porous beads, wherein the nanoparticles of step (a) are photoluminescent nanoparticles or mixed nanoparticles of photoluminescent nanoparticles and another nanoparticles, wherein the another nanoparticle is one or more than two mixed, selected from a group consisting of magnetic nanoparticle, metallic nanoparticle and metal oxide nanoparticle.

According to the present invention, photoluminescent nanoparticles or photoluminescent nanoparticles and another nanoparticles are uniformly doped within the porous bead so that nanoparticle-doped porous bead, having an enhanced fluorescence intensity without wavelength shift and an increased durability, can be fabricated in a quantitative yield with a size in the range of several tens nanometer to several micrometer.

The nanoparticle-doped porous bead fabricated according to the present invention can be employed very usefully as materials for LED lighting, lasers, displays and the like, and also be utilized as bio-imaging materials and environment associated sensors capable of executing diagnose, cure and the like for diseases with a high sensitivity.

Specifically, for the LED lighting coming into a spotlight as highly efficient and eco-friendly lighting, it is currently in the state that blue light and red light are mixed to create light close to red for use without any ingredient of red light being separately provided. Therefore, if a red light emitting material is provided, it could be a revolutionary change in the LED lighting industry. Also, in this case, since the full-width at half-maximum of the fluorescence is so narrow that it does not need a filter, light source can sufficiently be provided with low energy, thereby enhancing a power saving function. Furthermore, a doped bead having fluorescence properties and magnetism is expected to be used in an highly advanced field, such as for bio-imaging, environment associated sensors and the like.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional schematic view showing a nanoparticle layer doped porous bead in accordance with the present invention;

FIG. 2 is a view showing fluorescence spectra of a quantum dot solution or silica bead doped with a quantum dot layer in accordance with the present invention, wherein FIG. 2(a) shows the fluorescence spectrum of a quantum dot solution, fabricated in step (1) of Example 1, to which chargeable molecules are attached, FIG. 2(b) shows the fluorescence spectrum of a silica bead, fabricated in step (3) of Example 1, on which a quantum dot layer is doped, and FIG. 2(c) shows the fluorescence spectrum of a silica bead solution, fabricated in step (4) of Example 1, within which a quantum dot layer fabricated in step (3) of Example 1 is encapsulated near the surface thereof;

FIG. 3 is scanning electron microscopy (SEM) images of silica beads doped with a quantum dot layer in accordance with the present invention, wherein FIG. 3(a) shows the SEM image of a silica bead, fabricated in step (2) of Example 1, to which chargeable molecules are attached, FIG. 3(b) shows the SEM image of a silica bead, fabricated in step (3) of Example 1, on which a quantum dot layer is doped, and FIG. 3(c) shows the SEM image of a silica bead, fabricated in step (4) of Example 1, within which a quantum dot layer fabricated in step (3) of Example 1 is doped near the surface thereof;

FIG. 4 is transmission electron microscopy (TEM) images of silica beads doped with the quantum dot layer in accordance with the present invention, wherein FIG. 4(a) shows the TEM image of a silica bead, fabricated in step (2) of Example 1, to which chargeable molecules are attached, FIG. 3(b) shows the TEM image of a silica bead, fabricated in step (3) of Example 1, on which a quantum dot layer is doped, and FIG. 3(c) shows the TEM image of a silica bead, fabricated in step (4) of Example 1, within which a quantum dot layer fabricated in step (3) of Example 1 is doped near the surface thereof; and

FIG. 5 is TEM images of silica beads doped with a mixed particle layer of photoluminescent nanoparticles and another nanoparticles in accordance with the present invention, wherein FIG. 5(a) shows the TEM image of a silica bead, fabricated in step (2) of Example 2, on which a mixed particle layer of photoluminescent nanoparticles and iron oxide nanoparticles fabricated in step (1) of Example 2 is doped, and FIG. 5(b) shows the TEM image of a silica bead, fabricated in step (3) of Example 2, in which a mixed particle layer of photoluminescent nanoparticles and iron oxide nanoparticles, fabricated in step (2) of Example 2 is doped near the surface thereof.

### DETAILED DESCRIPTION OF THE INVENTION

Description will now be given in detail of the examples of the present invention, with reference to the accompanying drawings.

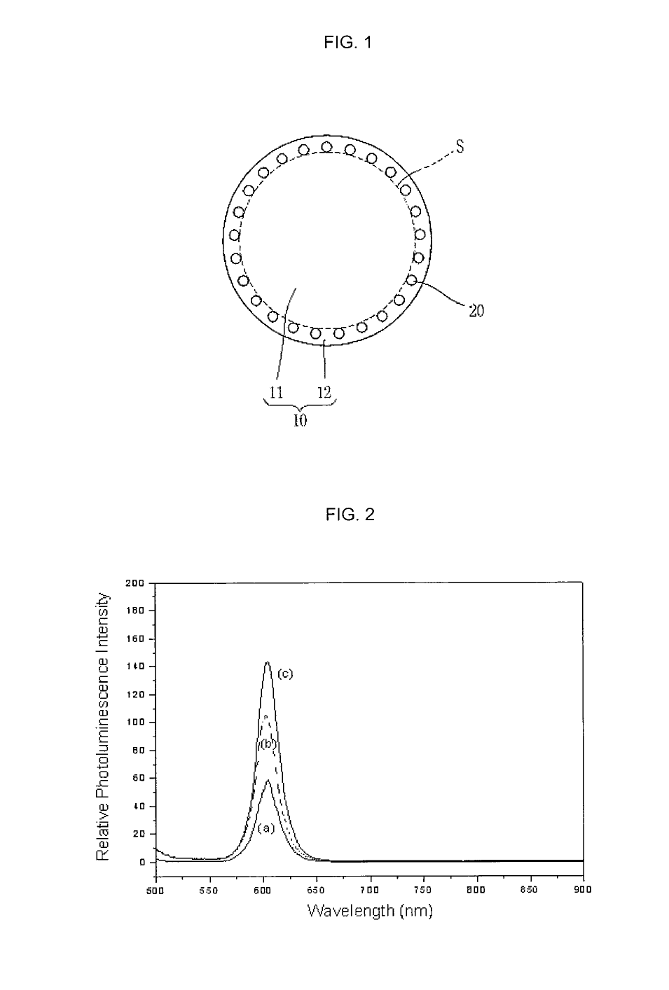

As shown in FIG. 1, a nanoparticle-doped porous bead in accordance with one aspect of the present invention consists of a porous bead 10, and nanoparticles 20 radially bonded by an electrostatic attractive force onto a homocentric sphere inside the porous bead 10 near a surface of the porous bead 10. The nanoparticles may be photoluminescent nanoparticles, or be nanoparticles of photoluminescent nanoparticles and another nanoparticles being mixed together.

In this example, the porous bead 10 may contain a centric porous bead 11 having as an outer surface a surface S of the concentric sphere, to which the nanoparticles 20 are attached (bonded), and a porous layer 12 formed at the surface of the centric porous bead 11 for covering the nanoparticles 20 attached by the electrostatic attractive force. Here, preferably, a diameter of the centric porous bead 11 may be more than or equal to a diameter of the nanoparticle and less than or equal to 10 μm, each nanoparticle (diameter for a spherical nanoparticle) may be in the range of 1 nm to 20 nm in size, and the porous layer may be in the range of 1 nm to 100 nm (more preferably 1 nm to 50 nm) in thickness. If the diameter of a centric porous body is shorter than the diameter of the nanoparticle, the nanoparticles may not uniformly be doped onto surface of the centric porous body by the electrostatic attractive force, and also the synthesis of the porous body with a diameter more than or equal to 10 μm may not be obvious. If the size of the quantum dot as the nanoparticle is generally in the range of 1 nm to 20 nm, the photoluminescence properties by quantum confinement effect are observed. Also, when photoluminescent nanoparticles are mixed with another nanoparticles for use, if the size of each particle is in the same range of 1 nm to 20 nm, the properties as nanoparticles are well observed, and such mixture is preferable to form a uniform monolayer. It was observed that the photoluminescence properties were enhanced or maintained until the porous layer was about 130 nm in thickness and decreased when the same was about 150 nm in thickness. This is because light transmission is interfered if the porous layer becomes too thick.

According to the present invention, the nanoparticles 20 are doped inside the porous bead 10 in the form of a spherical shell formed as a monolayer by being radially located at the same distance from the center of the porous bead 10. Since the photoluminescent nanoparticles 20 exist as the monolayer on the surface of the homocentric sphere, the self quenching can be minimized, and the nanoparticles 20 can emit fluorescence enhanced by resonance of the photons with cavity modes of the centric porous bead 11. Also, the photoluminescent nanoparticles 20 are covered with the porous layer 12 to be confined within the porous bead 10. Accordingly, photo-stability and durability can be improved better than independently existing photoluminescent nanoparticles 20, and simultaneously photoluminescence intensity can be further enhanced by the resonance coupling between the photoluminescent nanoparticles 20 and the cavities of the porous layer 12.

According to the present invention, preferably, the homocentric sphere has a radius r, which is more than or equal to 0.5 times of a distance (radius; R) from the center of the porous bead 10 to a surface thereof, and less than one time of the distance. If the homocentric sphere has a radius r which is less than 0.5 times of the radius R, the photoluminescent nanoparticles 20 are doped deeply inside the porous bead 10, and accordingly the fluorescence emitted out of the porous bead 10 becomes drastically weak. The upper limit of being less than one time of the radius R denotes that the photoluminescent nanoparticles 20 are not to be exposed from the porous bead 10.

One of key points of the present invention is to uniformly dope a monolayer of nanoparticles within the porous bead 10 near the surface thereof without use of organic polymers. As stated in the related art, several attempts to dope a nanoparticle layer (i.e., quantum dot layer) onto the porous bead were often made, but no attempt successfully achieved a fabrication of a quantum dot-doped porous bead with improved fluorescence intensity and durability and maintained fluorescent wavelength by doping a monolayer with a uniform density. The present inventors provide a doped layer with a uniform density without an oxidation of quantum dots through a quantum dot doping by an electrostatic attractive force other than a covalent bonding substitution, in a state of excluding the use of organic polymers. Detailed methods relating to this will be explained later.

A layer in the present invention includes a layer being positioned on a homocentric sphere without being formed as a complete film as well as a layer formed as a complete film.

The porous bead 10 may contain one or a mixture of more than two, selected from a group consisting of silica, titania, zirconia and zeolite. However, the present invention may not be limited thereto, and be applicable to any porous bead if it consists of an inorganic material with high refractive index.

Further, the photoluminescent nanoparticle 20 may be at least one selected from a group consisting of II-VI compound semiconductor nanocrystals, III-V compound semiconductor nanocrystals and inorganic fluorescers. Here, examples of the II-VI compound semiconductor nanocrystals may include Cds, CdSe, CdTe, ZnS, ZnSe, ZnTe, HgS, HgSe, HgTe or the like, and examples of the III-V compound semiconductor nanocrystals may include GaN, GaP, GaAs, InP, InAs or the like. Also, examples of the inorganic fluorescers may include La₂O₂S:Eu, Li₂Mg(MoO₄):Eu,Sm, (Ba, Sr)₂SiO₄:Eu, ZnS:Cu,Al, SrGa₂S₄:Eu, Sr₅(PO₄)₃Cl:Eu, (SrMg)₅PO₄Cl:Eu, BaMg₂Al₁₆O₂₇:Eu or the like. In addition, the photoluminescent nanoparticles 20 may have a core and shell structure including a core and a shell coated on an outer surface of the core. For instance, the photoluminescent nanoparticles 20 may have a structure of II-VI compound semiconductor nanocrystal (core)/II-VI compound semiconductor nanocrystal (shell) (e.g., CdSe/ZnS), a structure of III-V compound semiconductor nanocrystal (core)/III-V compound semiconductor nanocrystal (shell) (e.g., InP/GaN), or a structure of III-V compound semiconductor nanocrystal (core)/II-VI compound semiconductor nanocrystal (shell) (e.g., InP/ZnS). However, the present invention may not be limited thereto.

The different nanoparticles 20 may be magnetic nanoparticles, metallic nanoparticles or metallic oxide nanoparticles. Here, the metal may be at least one selected from a group consisting of Au, Ag, Fe, Co and Ni, and the metallic oxide may be at least one selected from a group consisting of FeO, Fe₂O₃, Fe₃O₄, MnFe₂O₄, CoFe₂O₄ and NiFe₂O₄.

In accordance with another aspect of the present invention, a nanoparticle-doped porous bead may consist of centric porous beads 11, nanoparticles 20 radialy bonded onto surfaces of the centric porous beads 11 by an electrostatic attractive force, and a porous body 12 for covering the nanoparticles 20.

Here, each of the nanoparticles 20 is preferably doped on the same distance from the center of the centric porous bead 11 so as to form a monolayer. As aforementioned, this is to minimize the self quenching for photoluminescent nanoparticles.

Also, the centric porous bead 11 and the porous body 12 may be formed of the same material. In an alternative example, the centric porous bead 11 and the porous body 12 may be formed of different materials.

Hereinafter, description will be given of a fabrication method of nanoparticle-doped porous bead using silica as the porous bead in accordance with an example.

In the existing fabrication method of nanoparticle-doped silica bead, trialkoxysilane having a mercapto group was bonded to silica to produce a water-soluble silica solution containing silica with the mercapto group exposed externally. The silica solution was directly contacted with a hydrophobic quantum dot solution with quantum dots distributed in a nonpolar organic solvent, such as chloroform, so as to dope the quantum dots onto the silica in a manner that surfactants on the quantum dots were substituted by the mercapto groups on the silica. According to the existing method, several covalent bonds are formed simultaneously between one quantum dot and the mercapto groups, so that the quantum dots doped on the silica were not relocatable, which resulted in a non-uniform quantum dot doping and a very low doping density and caused a problem in usage thereof due to a weak fluorescence intensity. For reference, it has been known that upon the mercapto groups being bonded onto the quantum dots, if steric hindrance occurs, a defect structure is formed on the quantum dots and accordingly electrons excited to a conduction band are back to a valence band without radiation via a trap state, thereby reducing fluorescence.

To solve the problem, a method was developed that polyelectrolytic polymers were first doped onto silica and then quantum dots were doped onto the polymers. However, in this method, quantum dots were doped at various positions due to different positions of cationic functional groups fixed onto the polymers and additionally the quantum dots were oxidized by the polycation, such that fluorescence intensity was weakened and its blue shift could not be avoided.

Hence, the present inventors determined to fabricate a porous bead with photoluminescent nanoparticle layer being uniformly doped on a homocentric sphere of porous homocentric sphere in a state of excluding the use of polycationic polymers around the photoluminescent nanoparticles in order to develop a porous bead with enhanced fluorescence intensity without wavelength shift due to photoluminescent nanoparticle doping. As a result of the effort, after molecules capable of being charged into opposite charges were uniformly bonded respectively to silica beads and quantum dots to obtain respective aqueous solutions, pHs of those solutions were then adjusted to produce hydraulic monodispersed solutions. These two solutions were mixed so as to uniformly dope a quantum dot layer on the silica beads by an electrostatic attractive force, thereby preparing silica beads with an enhanced fluorescence without wavelength shift. Also, the present inventors developed a method for fabricating silica beads with further enhanced fluorescence, maintained fluorescent wavelength and superior photo-stability and durability, by growing a silica layer directly on the quantum dot layer and confining the quantum dot layer (i.e., photoluminescent nanoparticle layer) inside the silica bead near the surface of the silica bead.

If the nanoparticles include photoluminescent nanoparticles and another nanoparticles, particularly, magnetic nanoparticles, a monodispersed different nanoparticle solution having the same pH and charge is added to the pH-adjusted monodispersed solution to prepare a nanoparticle mixed solution, and then the resultant solution is mixed with monodispersed silica bead with different pH and charge so as to uniformly dope the photoluminescent nanoparticles and the another nanoparticles onto the silica beads by an electrostatic attractive force, thereby fabricating silica beads having the enhanced fluorescence without wavelength shift and simultaneously having the properties of another particles, such as magnetism. Further, a fabrication method was developed for silica beads having an enhanced fluorescence without wavelength shift, superior photo-stability and durability and magnetism, by growing a silica layer directly on the mixed nanoparticle layer so as to confine the mixed nanoparticle layer inside the silica bead near the surface of the silica bead. Therefore, as far as the nanoparticles are not aggregated in the pH-adjusted aqueous solution, the same results can be obtained even if the nanoparticle mixed solution containing the photoluminescent nanoparticles and magnetic nanoparticles is used.

Preferably, the photoluminescent nanoparticles and the another nanoparticles are mixed in the ratio that the number of another nanoparticles is 1 to 5 mol % as much as the number of photoluminescent nanoparticles. The another nanoparticles badly work to the growing of the porous layer after forming a nanoparticle layer, as compared to a quantity of photoluminescent nanoparticles. Therefore, it is preferable that the number of the photoluminescent nanoparticles contained is greater than that of the another nanoparticles.

The above embodiment illustrated an example that silica was used as a porous bead (including porous layer); however, it can be equally applied to a case of using titania, zirconia or zeolite as the porous bead. In addition, the present invention may not be subject to limitation if a porous bead consists of an inorganic material with high refractive index.

As such, a fabrication method for a nanoparticle-doped porous bead according to the present invention may include respectively adjusting pH of a nanoparticle solution containing nanoparticles with a surface to which molecules chargeable into a first charge are attached and pH of a porous bead solution containing porous beads with surfaces to which molecules chargeable into a second charge, the second charge having an opposite polarity to the first charge, are attached, so as to prepare monodispersed nanoparticle solution and monodispersed porous bead solution having different charges from each other; mixing the monodispersed nanoparticle solution with the monodispersed porous bead solution to bond the nanoparticles respectively to the surfaces of the porous beads by an electrostatic attractive force; and forming a porous layer so as to cover the nanoparticles attached to the surfaces of the porous beads. Here, the porous bead solution is a polyanionic solution if the nanoparticle solution is a polycationic solution, whereas the porous bead solution is a polycationic solution if the nanoparticle solution is a polyanionic solution. The nanoparticle solution may contain only photoluminescent nanoparticles, or both photoluminescent nanoparticles and another nanoparticles.

Here, the porous bead preferably has a spherical shape.

In the fabrication method, the photoluminescent nanoparticle or magnetic nanoparticle having the chargeable molecules bonded thereto and the porous bead are well-known materials, and a method for fabricating the same is also well-known. In general, after being bonded to particles, the molecules, which expose amine group NH₂, carboxyl group (COOH) or hydroxyl group (OH) or phosphonate group (PO₃⁻) from their surfaces, are hydrophilic and chargeable in water, thereby increasing the dispersal of particles in water.

The present inventors observed a partial aggregation when the photoluminescent nanoparticle contained solution or another nanoparticle contained solution and the silica bead contained solution were solutions at pH close to neutrality without pH adjusted, and also observed a precipitation of particles with being clumped together when such aggregation is continued. Also, they ascertained that a nanoparticle layer less than 20 nm in size, such as quantum dot, could not be uniformly doped on a large bead such as silica when particles were aggregated. Since the aggregated clump of quantum dots are doped on the silica beads so weakly as to be easily apart therefrom, a uniform doping layer is not formed. Alternatively, even if monodispersed quantum dots are doped on the aggregated silica beads, since the quantum dots cannot be close to the aggregation surfaces at which the silica beads are directly contacted with each other, the quantum dot layer cannot be uniformly doped on a homocentric sphere on the silica beads. In case where the quantum dots and the silica beads are all aggregated, the non-uniform doping may become severe, thereby drastically deteriorating the property of matter.

Accordingly, the present inventors made each of particles have the maximum charged amount by adjusting pHs of the nanoparticle contained solution having chargeable molecules bonded thereto and the porous bead contained solution, respectively, so that a repulsive force among particles having the same charge was increased, thereby fabricating hydrodynamically monodispersed solutions without aggregation, respectively. Then, the two monodispersed solutions having opposite charges due to the pH adjustment were mixed together so as to uniformly dope a small nanoparticle layer on a large silica bead by an electrostatic attractive force. In addition, a silica layer was grown directly on the nanoparticle layer, and accordingly a nanoparticle-doped porous bead in which the nanoparticle layer was uniformly doped was obtained. Such nanoparticle-doped porous bead was then provided in a quantitative yield. Here, the pH adjustment for fabricating the monodispersed nanoparticle solution or the monodispersed porous bead solution is in the range that the amine group or carboxyl group exposed on the surfaces of the nanoparticles and the porous beads can have positive charge or negative charge, so it is preferably in the range of pH 3 to 5 for amine group and pH 9 to 11 for carboxyl group.

### EXAMPLES

Hereinafter, the present invention will be described in detail in accordance with examples; however, those examples are merely provided to help the present invention to be understood more obviously, not purposing to limit the scope of the present invention. The present invention may be embodied within the scope of the claims to be disclosed later.

In Example 1 herebelow, a hydrophobic quantum dot (CdSe/CdS-ODA) used as a starting material of a polyanionic monodispersed quantum dot is coordinated by octadecylamine (ODA) on an entire surface thereof. That is, the hydrophobic property comes from the carbon chains of the coordinated ODA and the quantum dot is in a core and shell structure fabricated by a method disclosed in a document (BioMEMS and Nanotechnology II, Proc. of SPIE Vol. 6036, 60361N-1˜8, 2006). Chargeable molecules, such as mercaptopropionate, were bonded to such hydrophobic quantum dots, and thereafter pHs thereof were adjusted for use. Also, in the following Example 2, hydrophobic superparamagnetic iron oxide nanoparticles (SPION-OA), used as a starting material of polyanionic monodispersed magnetic nanoparticles, are coordinated by oleic acid (OA) on an entire surface thereof. Such iron oxide nanoparticles were fabricated by a method disclosed in a document (Chemistry of Materials Vol. 16, 2814˜8, 2004). Chargeable molecules, such as carboxyethyl phosphonate, were bonded to the hydrophobic superparamagnetic iron oxide nanoparticles, and then pHs thereof were adjusted for use. Further, in Example 1, silica bead used as a starting material of the polycationic monodispersed silica bead has a surface consisting of silanol group (Si—OH). Chargeable molecules, such as aminopropyl group, were bonded to silica beads commercially purchased or those fabricated by a stöber process so as to be used. However, any photoluminescent nanoparticles and/or another nanoparticles both having chargeable molecules bonded to surfaces thereof and any silica beads may be equally applicable to Examples 1 and 2, regardless of a fabrication method.

### Example 1

### Fabrication of Silica Bead with Quantum Dot (Photoluminescent Nanoparticle) Layer Doped Therein

(1) Fabrication of polyanionic monodispersed quantum dot CdSe/CdS(—SCH₂CH₂CO₂⁻)ₑₓ aqueous solution

5 ml of quantum dot solution (2×10⁻⁵ M) in a core and shell structure (CdSe/CdS-ODA) with a surface protected by octadecylamine (ODA) was prepared and evaporates a hexane solvent therefrom by vacuum. The resultant solution was dispersed in 10 ml of chloroform, to which a methanol solution having 0.05 M mercaptopropionic acid (MPA) and 0.06 M sodium hydroxide melted therein, was then excessively added, thereafter being strongly stirred for 30 minutes. When 2 to 3 mL of distilled water was added to the stirred solution, quantum dots came up to a water layer, which was then separated. Methanol and ethylacetate were added into the separated water layer, thereby collecting the quantum dots by a centrifugal separation. Such quantum dots were dispersed in water and pH of the solution was then adjusted to approximately 10 by using a diluted sodium hydroxide solution, thereby fabricating 100 mL (1×10⁻⁶ M) of polyanionic monodispersed quantum dot (CdSe/CdS(—SCH₂CH₂CO₂—)ₑₓ) aqueous solution, in which carboxylic acid on the quantum dot surface was in —CO₂⁻ state. Here, According to thermal analysis results, it was determined that more than 300 MPA molecules were bonded to the quantum dot surfaces, which was indicated by ex, and a fluorescence spectrum of this solution was shown in FIG. 2(a).

(2) Fabrication of Polycationic Monodispersed Silica Bead Aqueous Solution

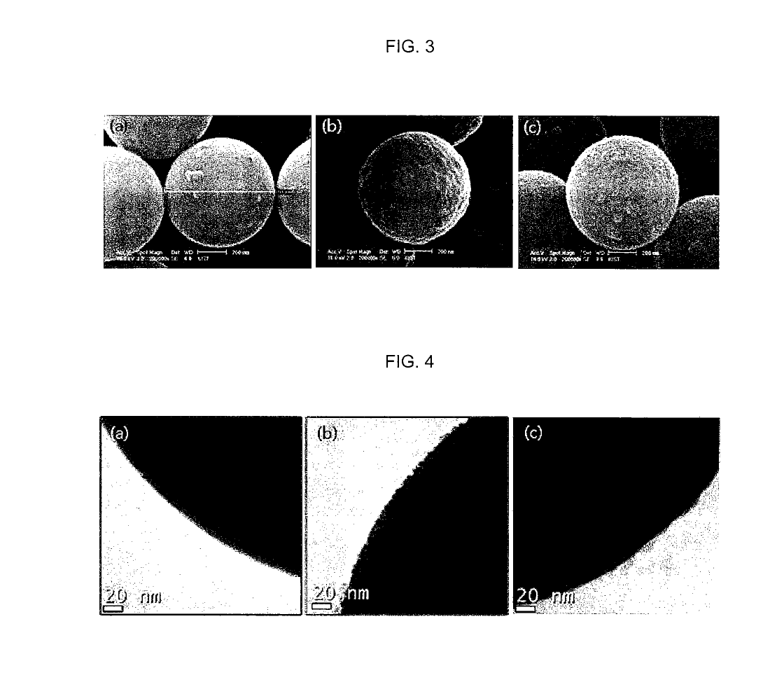

5 mL of silica bead solution (DLS size 1.0±0.05 μm, 10 wt %) purchased from Polyscience Co., Ltd was centrifugally separated, and dispersed in 20 mL of methanol. 0.025 mL of aminopropyltrimetoxysilane was added into the solution, thereby refluxed for 10 hours. After being cooled, this solution was rinsed with methanol 3 or 4 times by use of the centrifugal separation. Finally, the resultant solution was dispersed in 10 mL of ethanol and several drops of diluted hydrochloric acid were added thereto so that pH of the solution was adjusted to approximately 4, thereby fabricating a polycationic monodispersed silica bead solution in which amine on the silica bead surface was in —NH₃⁺ state. SEM and TEM images of the silica bead were shown in FIG. 3(a) and FIG. 4(a). Since the core size of the silica bead is about 800 nm, the change in a surface image was represented by enlarged part of the bead in the TEM image showing the more detailed portion.

(3) Fabrication of Silica Bead with Quantum Dot (Photoluminescent Nanoparticle) Layer Doped Thereon

The polycationic silica bead solution fabricated in the aforesaid step (2) was slowly added into the polyanioic quantum dot solution fabricated in the aforesaid step (1) and shaken to be uniformly mixed together. Such action was stopped at the time when precipitation was generated, and then the solution was centrifugally separated after performing a gentle vortex-process for 1 minute. Negligible fluorescence was detected from the filtrate, which was accordingly discarded. The precipitate was dispersed in 400 mL of ethanol, thereby fabricating a silica bead solution with the quantum dot layer doped on its surface. The fluorescence spectrum of the silica bead was shown in FIG. 2(b), and SEM and TEM images thereof were shown in FIG. 3(b) and FIG. 4(b).

(4) Fabrication of Silica Bead with Quantum Dot (Photoluminescent Nanoparticle) Layer Doped Therein

12 mL of distilled water and 4 mL of strong ammonia solution were added to the silica bead solution having a surface doped with the quantum dot (photoluminescent nanoparticle) layer, fabricated at the aforesaid step (3). The mixed solution was then stirred. Afterwards, 2 mL of tetraethoxysilane (TEOS) was poured into the solution to be stirred for 3 hours to grow, as a silica layer on the silica bead having the surface doped with the quantum dot layer, thereby fabricating a silica bead with the quantum dot layer being doped inside the silica bead near the surface thereof. This solution was centrifugally separated, and the precipitates were rinsed with ethanol. The resultant was centrifugally separated again, to be dispersed in 20 mL of ethanol. The fluorescence spectrum of this silica bead was shown in FIG. 2(c) and SEM and TEM images were shown in FIG. 3(c) and FIG. 4(c), respectively.

### Example 2

### Fabrication of Silica Bead with Mixed Layer of Photoluminescent Nanoparticles and Another Nanoparticles Doped Therein

(1) Fabrication of Polyanionic Monodispersed Iron Oxide Nanoparticle SPION (—O₂CCH₂CH₂PO₃⁻)ₑₓ aqueous solution

0.08 g of Trioctylammonium bromide was added to 10 mL of iron oxide nanoparticle (SPION-OA) solution having a surface protected by olein acid (OA) to be shaken for one day. To this solution was added 10 mL of solution containing 0.1 M carboxyethyl phosphonate, to thereby be shaken for another one day. When water and methanol were sequentially added to the resultant solution to be centrifugally separated, precipitates were generated. The precipitates were rinsed with ethanol and then centrifugally separated. Such precipitates were dispersed in water and pH of the solution was adjusted to approximately 10 by use of a diluted sodium hydroxide solution, thereby fabricating 190 mL (2×10⁻⁸ M) of polyanionic monodispersed nanoparticle (SPION(—O₂CCH₂CH₂PO₃)ₑₓ) aqueous solution in which phosphonate of the nanoparticle surface is in —PO₃⁻ state.

(2) Fabrication of Silica Bead with Photoluminescent Nanoparticles and Another Nanoparticles Doped Thereon

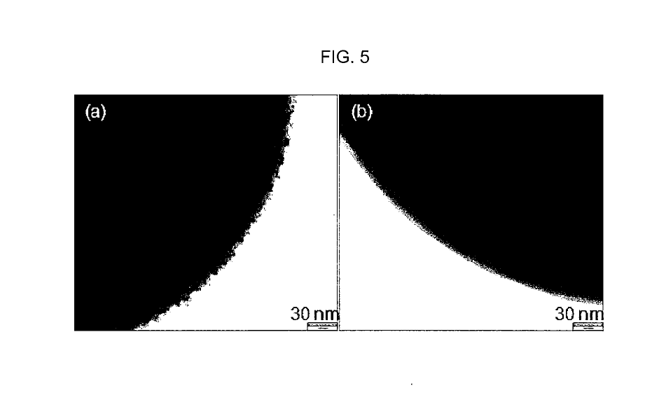

5 mL of the polyanionic quantum dot solution fabricated in step (1) of Example 1 and 5 mL of the polyanionic another nanoparticle solution fabricated in step (1) of Example 2 were mixed together to prepare 10 mL of mixed nanoparticle solution containing the quantum dots and the another nanoparticles. The polycationic silica bead solution fabricated in step (2) of Example 1 was slowly added into the mixed nanoparticle solution, which were then shaken to be uniformly mixed together. Such action was stopped at the time when precipitation was generated, and then the solution was centrifugally separated after performing a gentle vortex-process for 1 minute. Negligible fluorescence was detected from the filtrate, which was accordingly discarded. The precipitates were dispersed in 40 mL of ethanol, thereby fabricating a silica bead solution with a surface doped with a mixed layer containing the photoluminescent nanoparticles and another nanoparticles. The TEM image of this silica bead was shown in FIG. 5(a).

(3) Fabrication of Silica Bead with Mixed Layer of Photoluminescent Nanoparticles and Another Nanoparticles Doped Therein

1.2 mL of distilled water and 0.8 mL of strong ammonia solution were added into the silica bead solution having the surface doped with the mixed layer of the photoluminescent nanoparticles and the another nanoparticles, fabricated in the step (2), to be then stirred. Afterwards, 0.2 mL of tetraethoxysilane (TEOS) was poured into the solution to be stirred for 3 hours, so as to grow as a silica layer, on the silica bead having the surface doped with the mixed layer of quantum dots and iron oxide nanoparticles, thereby fabricating a silica bead having the mixed layer of photoluminescent nanoparticles and another nanoparticles doped inside thereof near the surface. After such silica bead solution was centrifugally separated and the precipitates were rinsed with ethanol, the resultant was centrifugally separated again and then dispersed in 10 mL of ethanol. As the result of comparing the fluorescence spectrum of this silica bead with the fluorescence spectrum of the mixed nanoparticle solution fabricated in the step (1) of Example 2, it was ascertained that fluorescence was increased in the same quantum dot concentration, and the TEM image of this silica bead was shown in FIG. 5(b). Compared with the image of FIG. 4, particles, which look like more black and slightly big dots, observed occasionally, are iron oxide nanoparticles. If a magnet is close to a vial containing the silica bead solution, the silica beads are attracted toward the magnet. Then, if the magnet is taken away and the vial is shaken, the silica bead solution is recovered to its originally uniform state.

It was ascertained from Examples 1 and 2 that the silica bead doped with the quantum dot layer was fabricated in an almost quantitative yield in the aspect that negligible fluorescence was detected from liquid which was discarded after adding insoluble solvent to the post-reacted solution or centrifugally separating the post-reacted solution as it was.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A nanoparticle-doped porous bead comprising:
porous beads; and
nanoparticles radially bonded onto homocentric spheres of the porous beads by an electrostatic attractive force, the homocentric sphere located inside the porous bead near a surface thereof,
wherein the nanoparticles are photoluminescent nanoparticles or mixed nanoparticles of photoluminescent nanoparticles and another nanoparticles,
wherein the another nanoparticle is one or more than two mixed, selected from a group consisting of magnetic nanoparticle, metallic nanoparticle and metal oxide nanoparticle.

2. The nanoparticle-doped porous bead of claim 1, wherein the porous bead consists of a centric porous bead having as an outer surface a surface of the homocentric sphere to which the nanoparticles are attached, and a porous layer configured to cover the nanoparticles attached to the surface of the centric porous bead by the electrostatic attractive force.

3. The nanoparticle-doped porous bead of claim 1, wherein the homocentric sphere has a radius more than or equal to 0.5 times of a distance from the center of the porous bead to the surface thereof and less than one time of the distance.

4. The nanoparticle-doped porous bead of claim 2, wherein the centric porous bead has a diameter in the range between a diameter of each nanoparticle and 10 each of the nanoparticles is in the range of 1 to 20 nm in size, and the porous layer is in the range of 1 to 100 nm in thickness.

5. A nanoparticle-doped porous bead comprising:
centric porous beads;
nanoparticles bonded to the surfaces of the centric porous beads by an electrostatic attractive force; and
a porous layer configured to cover the nanoparticles,
wherein the nanoparticles are photoluminescent nanoparticles or mixed nanoparticles of photoluminescent nanoparticles and another nanoparticles,
wherein the another nanoparticle is one or more than two mixed, selected from a group consisting of magnetic nanoparticle, metallic nanoparticle and metal oxide nanoparticle.

6. The nanoparticle-doped porous bead of claim 5, wherein each of the nanoparticles is located at the same distance from the center of the centric porous bead, so as to form a monolayer.

7. The nanoparticle-doped porous bead of claim 5, wherein the centric porous bead and the porous layer are formed of the same material.

8. The nanoparticle-doped porous bead of claim 1, wherein the porous bead contains one or a mixture of more than two selected from a group consisting of silica, titania, zirconia and zeolite.

9. The nanoparticle-doped porous bead of claim 1, wherein the photoluminescent nanoparticle is at least one selected from a group consisting of II-VI compound semiconductor nanocrystals, III-V compound semiconductor nanocrystals and inorganic fluorescers.

10. The nanoparticle-doped porous bead of claim 9, wherein the photoluminescent nanoparticle has one of the following core and shell structures (1) to (3):
(1) II-VI compound semiconductor nanocrystal (core) and II-VI compound semiconductor nanocrystal (shell) structure;
(2) III-V compound semiconductor nanocrystal (core) and III-V compound semiconductor nanocrystal (shell) structure; and
(3) III-V compound semiconductor nanocrystal (core) and II-VI compound semiconductor nanocrystal (shell) structure.

11. The nanoparticle-doped porous bead of claim 9, wherein the II-VI compound semiconductor nanocrystals comprises Cds, CdSe, CdTe, ZnS, ZnSe, ZnTe, HgS, HgSe and HgTe, the III-V compound semiconductor nanocrystals comprises GaN, GaP, GaAs, InP and InAs, and the inorganic fluorescers comprises La₂O₂S:Eu, Li₂Mg(MoO₄):Eu,Sm, (Ba, Sr)₂SiO₄:Eu, ZnS:Cu,Al, SrGa₂S₄:Eu, Sr₅(PO₄)₃Cl:Eu, (SrMg)₅PO₄Cl:Eu and BaMg₂Al₁₆O₂₇:Eu.

12. The nanoparticle-doped porous bead of claim 1, wherein the metal is at least one selected from a group consisting of Au, Ag, Fe, Co and Ni.

13. The nanoparticle-doped porous bead of claim 1, wherein the metallic oxide is at least one selected from a group consisting of FeO, Fe₂O₃, Fe₃O₄, MnFe₂O₄, CoFe₂O₄ and NiFe₂O₄.

14. A fabrication method for nanoparticle-doped porous bead comprising:
(a) preparing a monodispersed nanoparticle solution and a monodispersed porous bead solution, having opposite charges from each other, by respectively adjusting pH of a nanoparticle solution containing nanoparticles on which molecules chargeable into a first charge are bonded and pH of a porous bead solution containing porous beads on which molecules chargeable into a second charge are bonded, the first charge and the second charge having opposite polarities;
(b) mixing the monodispersed nanoparticle solution and the monodispersed porous bead solution so as to bond the nanoparticles onto the surfaces of the porous beads, respectively, by an electrostatic attractive force; and
(c) forming a porous layer to cover the nanoparticles bonded onto the respective surfaces of the porous beads,
wherein the nanoparticles of step (a) are photoluminescent nanoparticles or mixed nanoparticles of photoluminescent nanoparticles and another nanoparticles, wherein the another nanoparticle is one or more than two mixed, selected from a group consisting of magnetic nanoparticle, metallic nanoparticle and metal oxide nanoparticle.

15. The method of claim 14, wherein the porous bead has a spherical shape.

16. The nanoparticle-doped porous bead of claim 5, wherein the porous bead contains one or a mixture of more than two selected from a group consisting of silica, titania, zirconia and zeolite.

17. The nanoparticle-doped porous bead of claim 5, wherein the photoluminescent nanoparticle is at least one selected from a group consisting of II-VI compound semiconductor nanocrystals, III-V compound semiconductor nanocrystals and inorganic fluorescers.

18. The nanoparticle-doped porous bead of claim 17, wherein the photoluminescent nanoparticle has one of the following core and shell structures (1) to (3):
(1) II-VI compound semiconductor nanocrystal (core) and II-VI compound semiconductor nanocrystal (shell) structure;
(2) III-V compound semiconductor nanocrystal (core) and III-V compound semiconductor nanocrystal (shell) structure; and
(3) III-V compound semiconductor nanocrystal (core) and II-VI compound semiconductor nanocrystal (shell) structure.

19. The nanoparticle-doped porous bead of claim 17, wherein the II-VI compound semiconductor nanocrystals comprises Cds, CdSe, CdTe, ZnS, ZnSe, ZnTe, HgS, HgSe and HgTe, the III-V compound semiconductor nanocrystals comprises GaN, GaP, GaAs, InP and InAs, and the inorganic fluorescers comprises La₂O₂S:Eu, Li₂Mg(MoO₄):Eu,Sm, (Ba, Sr)₂SiO₄:Eu, ZnS:Cu,Al, SrGa₂S₄:Eu, Sr₅(PO₄)₃Cl:Eu, (SrMg)₅PO₄Cl:Eu and BaMg₂Al₁₆O₂₇:Eu.

20. The nanoparticle-doped porous bead of claim 5, wherein the metal is at least one selected from a group consisting of Au, Ag, Fe, Co and Ni.

21. The nanoparticle-doped porous bead of claim 5, wherein the metallic oxide is at least one selected from a group consisting of FeO, Fe₂O₃, Fe₃O₄, MnFe₂O₄, CoFe₂O₄ and NiFe₂O₄.
